(19) United States
(12) Patent Application Publication
(10) Pub. No.: US 2004/0013811 A1
(43) Pub. Date: Jan. 22, 2004

(54) Coating method

(75) Inventor: Yutaka Muranaka, Tokyo (JP)

Correspondence Address: Muserlian, Lucas and Mercanti, 600 Third Avenue, New York, NY, 10016, US

(73) Assignee: Konica Corporation, Tokyo (JP)

(21) Appl. No.: 10/618,557

(22) Filed: Jul. 11, 2003

(30) Foreign Application Priority Data
Jul. 18, 2002 (JP) JP2002-209537

(51) Int. Cl. B05D 1/36; B05D 1/30

(52) U.S. Cl. 427/402; 427/420

(57) ABSTRACT

A coating method, comprises steps of coating plural layers simultaneously on a continuously moving support by flowing out simultaneously plural coating liquids from plural slits, wherein at least one of the plural coating liquids contains a volatile solvent; stopping the coating step; and flowing out a solution containing a solvent having a boiling point higher than that of a main solvent of a coating liquid from a slit for an uppermost layer of the plural layers while stopping the coating step.

### BACKGROUND OF THE INVENTION

The present invention relates to a coating method which enhances quality as well as production efficiency of coating production.

As described in Edward Cohen and Edgar Gutoff, “Modern Coating and Drying Technology”, conventionally proposed as methods which apply a liquid coating composition onto a continuously moving belt-shaped support (hereinafter also referred to simply as a support), have been various methods. For example, known are a dip coating method, a blade coating method, an air knife coating method, a wire bar coating method, a gravure coating method, a reverse coating method, a reverse roller coating method, an extrusion coating method, a slide bead coating method, and a curtain coating method. Further, in these coating methods, in order to achieve a uniform dried layer thickness across the width of the support, coating is carried out while paying close attention to the accuracy and uniformity of the coating thickness.

A slide bead coating apparatus makes it possible to achieve high speed, a thin layer, and simultaneous multilayer coating. Due to these features, in recent years, the aforesaid slide bead coating apparatus has been used as a coating apparatus for light-sensitive photographic materials as well as magnetic recording materials. Listed as one of the preferred examples is a method employing the multilayer slide bead coating apparatus proposed in U.S. Pat. No. 2,761,791 by Russell, et al. In such a type coater, a maintained liquid coating composition, called a bead, is formed between the leading edge (also called simply a lip) of the slide surface and the moving flexible support (occasionally called the web), whereby coating is carried out via the aforesaid bead.

The aforesaid slide bead coating method exhibits the advantages as described above. However, on the other hand, it also results in the following problems. When a liquid coating composition, comprising volatile solvents, is employed specifically to form a lowermost layer, coat mottling tends to form very easily depending on the relationship of wettability characteristics with the support. Further, when the liquid coating composition, especially those comprising volatile solvents, is allowed to flow down on the slide surface of a coater, coat mottling tends to form more easily due to volatilization of the aforesaid volatile solvents. Still further, when a high viscosity liquid coating composition, comprising volatile solvents, is coated over an extended period of time, dried layers form especially at both edges of the coater due to retained coating composition or a decrease in the flow rate. As a result, serious coating problems occur, resulting in degradation of coating quality.

Still further, U.S. Pat. No. 3,289,632 and Japanese Patent Publication Open to Public Inspection No. 59-203666 propose that the shape, especially the height of the width regulating plate, provided at both edges of the slide surface of the coater matches the layer thickness of the liquid coating composition. However, it is difficult to state that the resulting effects sufficiently allow coating of the highly viscous liquid coating composition comprising volatile solvents over an extender period time, which is the aim of the present invention.

As countermeasures for these problems, it has been tried to minimize formation of mottling (stripe defects) by minimizing drying of the slide surface and the interior of die slits, while, prior to normal coating, flowing a low boiling point solvent over the slide surface during supply adjustment of the liquid coating composition to the coater. However, insufficient desired effects have been obtained.

Further, when a high viscosity liquid composition having a viscosity of 200 mPa.s or more, further having a viscosity of at least 300 mPa.s or more was coated, an effective means was that the lowermost layer coating composition was coated at a low viscosity of 20-50 mPa.s.

Still further, when a high viscosity liquid coating composition is initially supplied, the high viscosity liquid coating composition enters the slit for the lowermost layer, resulting in problems which cause undesired streak. As a result, countermeasures have been sought to avoid such drawbacks.

Still further, in the case of coating of a high viscosity liquid coating composition, it is essential to determine the optimal bead gap corresponding to various coating speed (CS), by trial and error, which takes time to learn such highly trained skill.

Still further, with regard to the width regulating plate, there are optimal materials, angles, and arrangement positions depending on the liquid coating compositions. However, such conversions take time, and complicate the work, resulting in lowered efficiency. In addition, an increase in layer thickness in both edges has not been sufficiently inhibited.

Still further, in the case of coating of the high viscosity liquid coating composition, when the vacuum mechanism and the waste composition recovery mechanism are the same, coat mottling forms. As noted above, in order to stabilize high speed coating of a low viscosity liquid coating composition, used has been a method in which pressure of the bead section, necessary for slide bead coating, was reduced. However, the aforesaid method has not resulted in desired sufficient function as in the case of coating of the high viscosity liquid coating composition.

### SUMMARY OF THE INVENTION

An objective of the present invention is to provide a coating method which solves the conventional technical problems described above and results in no problems of striping or mottling during coating of liquid coating compositions varying from low to high viscosity, and further results in neither insufficient drying nor problems making winding impossible due to an increase in layer thickness at both edges, and further a coating method in which the relationship between the flow rate, the viscosity and the coating speed of a liquid coating composition as well as the bead gap and an operation system, is coordinated to easily and accurately function, based on the resulting relationships.

Specific problems to be solved are as follows:

(1) When a liquid which flows on the slide surface is a low boiling point solvent and its flow amount is small, striping and mottling problems occasionally occur without hindering dryness of the slide surface.

(2) In the case of using the lowermost layer as a functional layer, even when its viscosity is at least 50 mPa.s, it has been required to carry out stable coating.

(3) Striping problems occasionally occur due to entry of a high viscosity liquid coating compositing into the slit feeding the lowermost layer.

(4) In the case of coating of a high viscosity liquid coating composition, it is essential that coating conditions are easily determined while clarifying the relationship between the CS and the bead gap.

(5) Depending on the shape and position of the width regulating plate, the thickness of both edges increases, whereby drying is not complete within the drying zone, resulting in staining of production processes as well as in quality degradation. Further, even though drying may be completed in the drying zone, occasionally it becomes impossible to carry out desired winding at the winding section.

(6) In the case of coating of a high viscosity liquid coating composition, mottling problems occur due to the vacuum mechanism for the liquid coating composition.

The aforesaid objective is achieved employing any of the following (1)-(13) technical means.

(1) In a coating method which simultaneously coats a plurality of layers onto a continuously moving support, a coating method wherein when at least one layer is coated which is comprised of a liquid coating composition comprising a volatile solvent, a solution comprising a solvent having a higher boiling point than the main solvent of said liquid coating composition is allowed to flow from the slit of the uppermost layer during periods other than coating.

(2) The coating method, described in (1), wherein it is possible to carry out coating even though said solvent is either a single component solvent or a solvent mixture consisting of a plurality of solvents.

(3) The coating method, described in (1) or (2), wherein said flow rate (ml/minute) satisfies the relationship of coating width (m)×50≦solvent flow rate≦coating width (m)×5,000.

(4) The coating method, described in any one of (1)-(3), wherein the surface air flow rate at the position where said liquid coating composition flows is at most 3 m/second.

(5) In a coating method which employs a slide bead coating system or a curtain coating system in which a plurality of layers are simultaneously coated onto a continuously moving support, a coating method wherein when at least one layer at a viscosity of at least 300 Pa·s comprises a volatile solvent, the minimum wet layer thickness of the lowermost layer is more than the thickness obtained by the following formula.

Y=0.0005X²+0.0858X+1.75

wherein Y represents the wet layer thickness (μm) of the lowermost layer and X represents the viscosity (mPa.s) of the lowermost layer.

(6) In a coating method which employs a slide bead coating system or a curtain coating system in which a plurality of layers are simultaneously coated onto a continuously moving support, a coating method wherein when at least one layer at a viscosity of at least 300 Pa·s comprises a volatile solvent, liquid coating compositions are subsequently supplied to a coater with said lowermost layer liquid coating composition being supplied first.

(7) The coating method, described in (6), wherein the supply flow rate of said lowermost liquid coating composition is higher than that of the liquid coating composition which is applied onto said layer.

(8) The coating method, described in (6), wherein the flow rate of said lowermost liquid coating composition is allowed to be less than that of the flow rate of other layers.

(9) In a coating method which employs a slide bead coating system in which a plurality of layers is simultaneously coated onto a continuously moving support, employing a slide coater, wherein coating is carried out while setting bead gap B (μm) between minimum value Bₘᵢₙ and maximum value Bₘₐₓ represented by the following formula for optional coating speed A (m/minute) in the range of 5-50 m/minute.

Bₘᵢₙ=58·logₑA

Bₘₐₓ=185·logₑA−100

(10) In a coating method which employs a slide bead coating system in which a plurality of layers is simultaneously coated onto a continuously moving support, employing a slide coater, wherein when at least one layer at a viscosity of at least 300 Pa·s comprises a volatile solvent, coating is carried out employing a bead gap determined by the following formula as an optimal value for the optional coating speed in the range of 5-50 m/minute.

B=60·logₑA+60

wherein A represents the coating speed (m/minute) and B represents the bead gap (μm).

(11) In a coating method which employs a slide bead coating system in which a plurality of layers is simultaneously coated onto a continuously moving support, employing a slide coater, wherein when at least one layer at a viscosity of at least 300 Pa·s comprises a volatile solvent, a front section angle, which is the angle (a tip end angle θₜ) between the inclined surface at the leading edge lip of the width regulating plate which regulates the coating width on the slide surface of said slide coater and said slide surface, and the side section angle, which is the angle (an inner side angle θᵢ) between the inner side declined surface of said width regulating plate and said slide surface, satisfy the condition of (α−40)°≦front section angle≦(α−5)°, wherein α represents the angle (a slide angle θ_{α}) between the moving surface of the support and said slide surface, and the condition of front section angle≦side section angle≦90° is also satisfied.

(12) In a coating method which employs a slide bead coating system in which a plurality of layers is simultaneously coated onto a continuously moving support, employing a slide coater, wherein when at least one layer at a viscosity of at least 300 Pa·s comprises a volatile solvent, a width regulating plate, which regulates coating width on a slide surface, is positioned so that the edge of the front side of said width regulating blade is matched to the front bar lip of the slide coater.

(13) In a coating method which employs a slide bead coating system in which a plurality of layers is simultaneously coated onto a continuously moving support, employing a slide coater, wherein when at least one layer at a viscosity of at least 300 Pa·s comprises a volatile solvent, a plurality of vacuum chambers to reduce pressure toward the upstream side in the support moving direction is arranged for the entire bead length.

### BRIEF DESCRIPTION OF THE DRAWINGS

FIG. 1 is a schematic view showing one example of the slide bead coating apparatus according to the coating method of the present invention.

FIGS. 2(a) to 2(c) are a plan view, a front view, and a side view of one portion of a coater die in the slide bead coating apparatus according to the coating method of the present invention.

FIG. 3 is a schematic view showing one example of the curtain coating method according to the present invention.

FIG. 4 is a graph showing the degree of stability in the range in which excellent coating is carried out while maintaining the coating speed at a definite value and varying the bead gap.

FIG. 5 is a schematic view showing the side layer thickness.

### DETAILED DESCRIPTION OF THE DRAWINGS

The embodiments of the present invention will now be described with reference to drawings. However, the present invention is not limited thereto. Further, in the following description, decisive expressions are occasionally given to terms and the like. However, these are employed to show the preferred examples of the present invention and do not limit the meaning of terms and the technical range of the present invention.

First, a specific example of the slide bead coating, which is the object of the present invention, will be described. Examples described below relate to coating of emulsions for light-sensitive photographic materials represented by general and industrial silver halide light-sensitive materials and heat-processable light-sensitive materials onto a transparent support such as PET. However the present invention is not limited to this example, but is also widely applicable to the production of, for example, magnetic recording materials such as magnetic recording tape, information recording media such as such as pressure-sensitive paper, thermosensitive paper, and ink jet paper, liquid compositions prepared by dissolving polymer materials in water and the like, pigment dispersions, and colloidal dispersions.

Further, the types of supports employed in the present invention are not limited, but it is possible to employ paper, plastic film, and metal sheets. Examples of paper include resin-coated paper and synthetic paper. Further, plastic films include polyolefin film (e.g., polyethylene film and polypropylene film), polyester film (e.g., polyethylene terephthalate film and polyethylene 2,6-naphthalate film), polyamide film (e.g., polyether ketone film), cellulose acetate (e.g., cellulose triacetate). Still further, the representative metal sheets include aluminum. In addition, the thickness of employed these supports is not specifically limited.

Examples of volatile solvents as described in the present invention include those shown below. Examples of volatile solvents in the present invention include ketones such as acetone, isophorone, ethyl amyl ketone, methyl ethyl ketone, and methyl isobutyl ketone; alcohols such as methyl alcohol, ethyl alcohol, n-propyl alcohol, isopropyl alcohol, n-butyl alcohol, isobutyl alcohol, diacetone alcohol, cyclohexanol, and benzyl alcohol; glycols such as ethylene glycol, diethylene glycol, triethylene glycol, propylene glycol, and hexylene glycol; ether alcohols such as ethylene glycol monomethyl ether, and diethylene glycol monoethyl ether; ethers such as ethyl ether, dioxane, and isopropyl ether; esters such as ethyl acetate, butyl acetate, amyl acetate, and isopropyl acetate; hydrocarbons such as n-pentane, n-hexane, n-heptane, cyclohexane, benzene, toluene, and hexylene; chlorides such as methyl chloride, methylene chloride, chloroform, and dichlorobenzene; amines such as monomethylamine, dimethylamine, triethanolamine, ethylenediamine, and triethylamine; and other solvents such as water, formamide, dimethylformamide, nitromethane, pyridine, toluidine, tetrahydrofuran, and acetic acid. However, the examples are not limited thereto. Further, these solvents may be employed individually or in various combinations of several types.

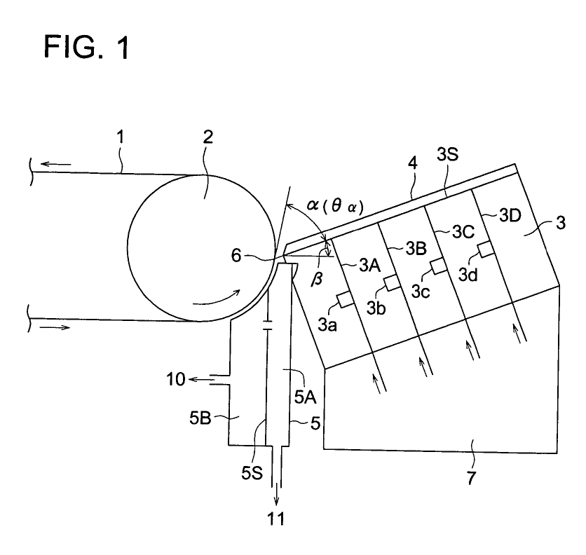

FIG. 1 is a schematic view showing one example of the slide bead coating apparatus according to the present invention.

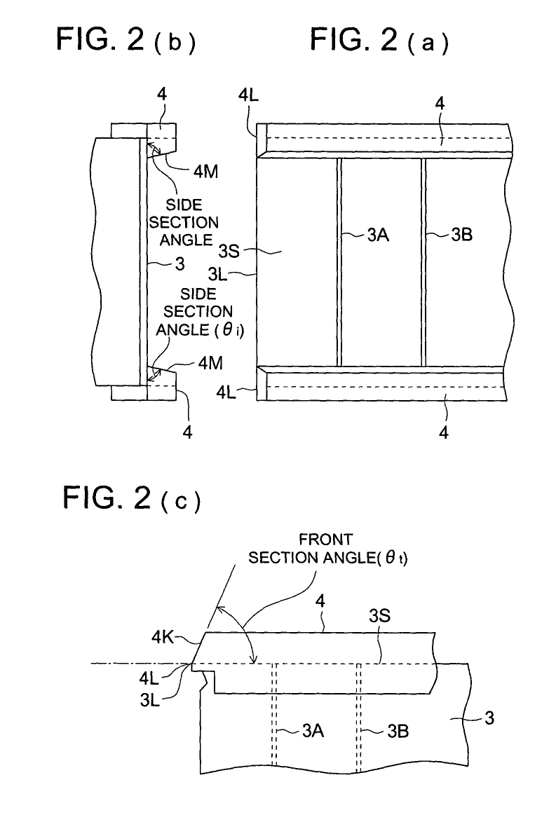

Continuously conveyed support 1 is maintained by back roller 2 which faces coater die 3 and rotates in the sane direction synchronized to the conveyance rate of said support 1 and is coated at liquid contact section 6. Coater die 3 is comprised of a plurality of blocks (FIG. 1 shows a structure of 4-layer simultaneous coating). Paired width regulating plate 4, which regulates the coating width, is arranged at both ends of slide surface 3S of coater die 3 as shown in (a) plan view, (b) front view, and (c) side view of FIG. 2. Further, coater die 3 is secured on coater carrier 7, while proving definite slide surface inclination angle β. Vacuum chamber 5 is arranged below and between back roller 2 and coater die 3 of said slide bead coating apparatus. In order to stabilize the bead formed in liquid contact section 6, vacuum chamber 5 creates a difference between the pressure above the bead and the pressure under the bead. Specifically, in order to decrease pressure of the lower section corresponding to the upstream side in the support conveying direction, air is exhausted through exhaust opening 10 so that the pressure in vacuum chamber 5 becomes negative. In the present invention, liquid contact section 6 is arranged in the lower portion as seen from the central position of back roller 2. Further, chamber 5 is divided into chambers 5A and 5B employing partition 5S. 5A is designed to accept excess coating compositions such as emulsions which fall through the vacuum chamber and allows them to flow down through waste composition opening 11 for recovery. Further, in 5B, exhaust opening 10 is arranged for suction and stabilizing the bead is intensively achieved. Still further, partition 5S is provided with an air flow opening so that chambers 5A and 5B can both be subjected to vacuum buildup.

Incidentally coater carrier 7 is arranged to be movable in the horizontal direction. Thus during preparation and adjustment prior to coating as well as prior to coating following the previous coating, it is possible to move coater die 3 of said slide bead coating apparatus to be withdrawn from liquid contract section 6, which is the coating position. In such a withdrawn position, it is possible to easily and accurately carry out adjustment work and operation.

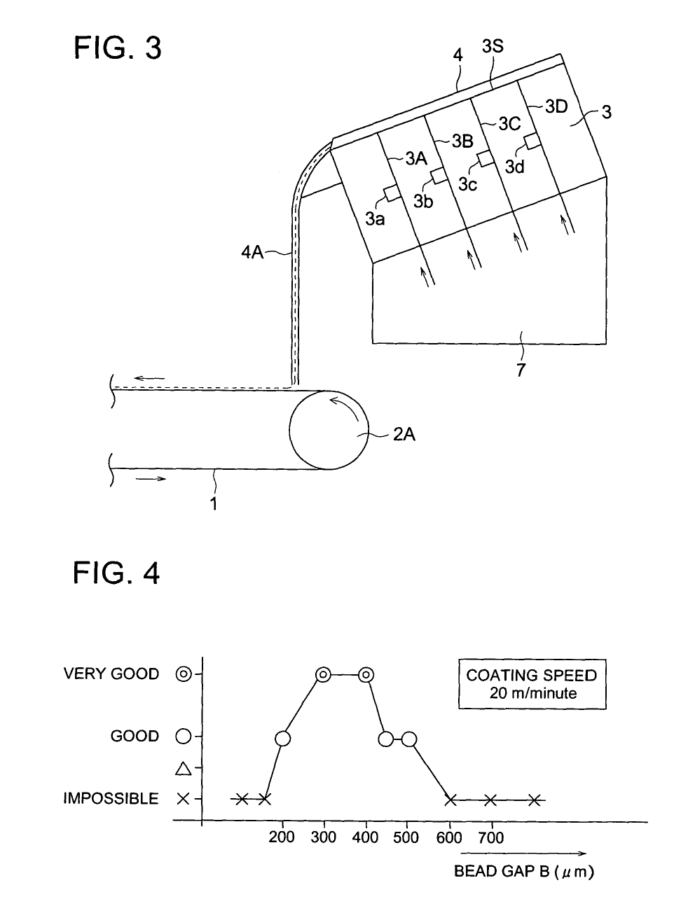

A curtain coating method will be described with reference to FIG. 3. Width regulating plate 4 for regulating coating width, employed in the slide bead coating method, is extended downward to form edge guide 4A. Between said edge guide 4A, formed is a curtain comprised of a coating composition. Subsequently a coated layer is formed by impinging the leading edge of the aforesaid curtain onto support 1 which is conveyed while maintained by back roller 2A arranged at a lower portion.

When a high viscosity liquid coating composition comprising volatile solvents is supplied to a coater for coating, a method is known in which the inside of liquid supply pipes to coater die 3, pockets 3a, 3b, 3c, and 3d in said coater die 3, and slits 3A, 3B, 3D, and 3D are previously wetted with solvents, and subsequently the liquid coating composition is supplied. However, when the boiling point of solvents is low and/or the flow rate is small, streaking, which is a coating problem, has inevitably occurred.

It has become possible to overcome streaking problems by making the boiling point of the aforesaid solvents higher than that of solvents in the liquid coating composition or adjusting the aforesaid flow rate to a specified range.

Further, when a high viscosity solution is subjected to slide bead coating or curtain coating, it has been essential to decrease the viscosity (to approximately 20 Pa·s or less) of the lowermost layer. However, even in the case of a relatively high viscosity lowermost layer, it has become possible to carry out coating by increasing the wet layer thickness of the lowermost layer. Further, it has become possible to easily calculate the minimum wet layer thickness of the lowermost layer. In the case of slide bead coating, it has become possible to easily calculate the relationship between the coating speed and the bead gap. Further it has become possible to simply and precisely select coating production conditions.

### EXAMPLES

The effects of the present invention will now be specifically described with reference to examples. However, the present invention is not limited to these embodiments.

In the present example, 3-layer slide bead coating is carried out. A first liquid coating composition is a liquid coating composition for the purpose of achieving the formation of a slide bead at the lowermost layer and stabilizing the resulted bead. The aforesaid liquid coating composition was prepared by dissolving 10.5 g of polyvinyl butyral powder (Butvar B-79 available from Monsanto Co.) in 100 g of methyl ethyl ketone (hereinafter also referred to as MEK) while stirred in a dissolver type homogenizer. The resulting composition is occasionally employed after addition of antifoggants and adhesion enhancing agents. Further, the second layer liquid coating composition, described below, may be used while diluted through a branched pipe.

The second layer liquid coating composition is a light-sensitive layer liquid coating composition which is prepared as described below.

(Preparation of Light-Sensitive Silver Halide Emulsion)

Dissolved in 900 ml of water were 7.5 g of ossein gelatin at an average molecular weight of 100,000, and 10 mg of potassium bromide. The resulting solution was maintained at 35 ° C. and the pH was adjusted to 3.0. Thereafter, added were 370 ml of an aqueous solution containing 74 g of silver nitrate and 370 ml of an aqueous solution containing potassium bromide and potassium iodide of a mol ratio of 98/2, being in the same mol as the aforesaid silver nitrate and iridium chloride in an amount of 1×10⁻⁴ mol per mol of silver over 10 minutes employing a controlled double jet method, while maintaining the pAg at 7.7. Thereafter, 0.3 g of 4-hydroxy-6-methyl-1,3,3a,7-tetraazaindene was added, and the pH was adjusted to 5 by adding NaOH, whereby prepared were cubic silver bromoiodide grains having an average grain size of 0.05 μm, a grain size variation coefficient of 12 percent, and a (100) plane ratio of 87 percent. The aforesaid emulsion was subjected to a desalting process while coagulated by a coagulant. After the desalting process, 0.1 g of phenoxyethanol was added, and the pH and the pAg were adjusted to 5.9 and 7.5, respectively, whereby a light-sensitive silver halide emulsion was prepared.

(Preparation of Organic Silver Salt Powder)

At 80° C., dissolved in 4,720 ml of pure water were 111.4 g of behenic acid, 83.8 g of arachidic acid, and 54.9 g of stearic acid. Subsequently, while stirring at high speed, 540.2 ml of a 1.5 mol/L sodium hydroxide aqueous solution was added, and 6.9 ml of concentrated nitric acid was then added. Thereafter, the resulting mixture was cooled to 55° C., whereby an organic acid sodium salt solution was prepared. While maintaining the aforesaid organic acid sodium salt solution at 55° C., the aforesaid light-sensitive silver halide emulsion in an amount corresponding to 0.038 mol in terms of silver and 450 ml of pure water were added and stirred for 5 minutes. Subsequently, 760.6 ml of 1 mol/L silver nitrate solution was added over 2 minutes and stirred for an additional 20 minutes. Thereafter, water-soluble salts were removed by filtration. Subsequently, washing and filtration were repeated employing deionized water until the electric conductivity of the filtrate reached 2 μS/cm, followed by centrifugal dehydration. Thereafter, drying was carried out under a flow of heated nitrogen gas until no weight decrease was noticed, whereby an organic silver salt powder was prepared.

(Preparation of Light-Sensitive Emulsion)

Dissolved in 1,457 g of methyl ethyl ketone (hereinafter referred to as MEK) was 14.57 g of polyvinyl butyral powder (Butvar B-79, available from Monsanto Co.). While stirring employing a dissolver type homogenizer, 500 g of the aforesaid organic silver salt powder was added and sufficiently blended. Thereafter, the resulting mixture was dispersed at a peripheral speed of 13 m and a retention time in the mill of 0.5 minute, employing a media type homogenizer (manufactured by Gettzmann Co.) filled to 80 percent with 1 mmφ Zr beads (manufactured by Toray Co.), whereby a light-sensitive emulsion was prepared.

(Preparation of Light-Sensitive Layer Liquid Coating Composition)

While stirring, 100 g of MEK was added to 500 g of the light-sensitive emulsion prepared as above and the resulting mixture was maintained at 24° C. After 30 minutes, 2.50 ml of 10 percent bis(dimethylacetamido)dibromobromate methanol solution was added and stirred for one hour. Further, 4 ml of 10 percent calcium bromide methanol solution was added and then stirred for 15 minutes. Subsequently, 1.8 ml of a mixed solution (20 weight percent Dye Stabilizer 1 methanol solution) of Dye Stabilizer 1 and potassium acetate at a weight ratio of 1:5 was added and stirred for 15 minutes. Subsequently, 7 ml of a mixture solution of Dye 1 as an infrared sensitizing dye and Dye Stabilizer 2 (at a mixing weight ratio of 1:250 and 0.1 weight percent MEK solution in terms of the sensitizing dye) was added and stirred for one hour. Thereafter, the resulting mixture was cooled to 13° C. and stirred for an additional 30 minutes. While maintained at 13° C., 48 g of polyvinyl butyral was added and completely dissolved. Subsequently, additives described below were added, whereby a light-sensitive layer liquid coating composition was prepared. Incidentally, all the aforesaid operations were carried out under a flow of nitrogen gas.

| | |
|---|---|
| Desmodur N3300 (aliphatic isocyanate, | 1.10 g |
| manufactured by Mobay Chemical Corp.) | |
| Antifoggant (2-(tribromomethylsulfonyl)- | 1.55 g |
| pyridine) | |
| 1.1-bis (2-hydroxy-3,5-dimethylphenyl)-2- | 15 g |
| methylpropane | |
| Tetrachlorophthalic acid | 0.5 g |
| 4-methylphthalic acid | 0.5 g |

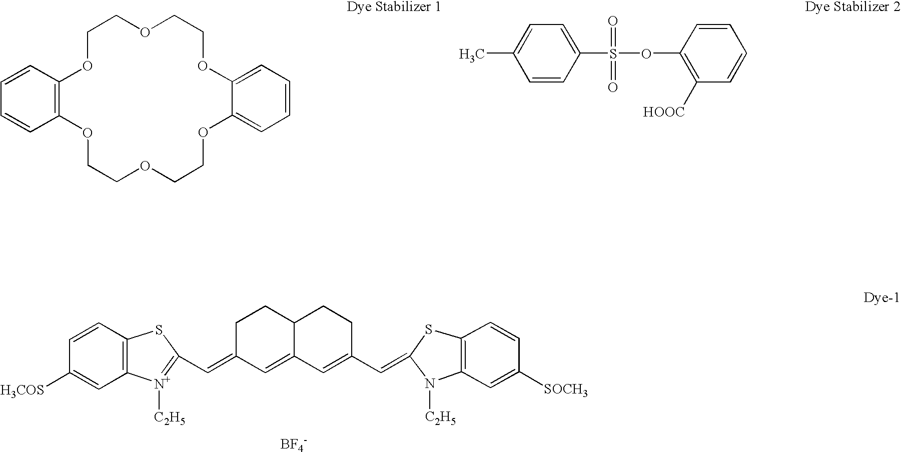

Viscosity was adjusted by varying the amount of binders and solvents.

A third layer was a surface protective layer of which liquid coating composition was prepared as described below.

(Preparation of Surface Protective Layer Liquid Coating Composition)

While stirring, added to and dissolved in 865 g of MEK were 96 g of cellulose acetate butyrate (CAB171-15, manufactured by Eastman Chemical Co.), 4.5 g of polymethyl methacrylic acid (Paraloid A-21, manufactured by Rohm & Haas Corp.), 1.5 g of Vinylsulfone Compound HD-1 (*1), 1.0 g of benzotriazole, and 1.0 g of an F based surfactant (Surfron KH40, manufactured by Asahi Glass Co.). Subsequently, 30 g of the matting agent dispersion, described below, was added and 15 g of phthalazine was then added while stirring, whereby a surface protective layer liquid coating composition was prepared.

(*1) HD-1: 1,3-{bis(vinylsulfonyl)}-2-hydroxypropane

<Preparation of Matting Agent Dispersion>

Dissolved in 42.5 g of MEK was 7.5 g of cellulose acetate butyrate (CAB171-15, manufactured by Eastman Chemical Co.). Subsequently, added to the resulting solution was 5 g of calcium carbonate (Super-Pflex 200, manufactured by Speciality Minerals Co.), and the resulting mixture was dispersed at 8,000 rpm for 30 minutes, employing a dissolver type homogenizer, whereby a matting agent dispersion was prepared.

A support was prepared as follows.

(Preparation of Support)

A 175 μm thick blue tinted polyethylene terephthalate film at a density of 0.160 (measured using Densitometer PDA-65, manufactured by Konica Corp.) was subjected to a corona discharge treatment of 8 W/m² on both sides, followed by a subbing treatment employing a prior art method.

By employing the samples prepared as above, coating was carried out employing a slide bead coating apparatus fitted with the coater die 3 as shown in FIGS. 1 and 2.

In Examples 1-4, a 1,000 m long support was coated.

In Examples 5-13, a 10 m long support was coated.

### Example 1

In a coating method in which a plurality of layers is simultaneously coated onto a continuously moving support, when a liquid coating compositions in which at least one layer liquid coating composition comprising volatile solvents is coated, the following coating method was tried. During the period except for coating, for example, during the adjustment period prior to coating, coater carrier 7 was withdrawn and as shown in FIGS. 1 and 3, and applied was a solution containing solvents having a boiling point of 85° C. and 90° C., respectively, as shown in Table 1, from slit 3D for the uppermost layer of coater die 3 shown in FIGS. 1 and 3, while the major solvent (MEK) of the liquid coating composition was at least 79.6° C. In such a manner, adjustment was smoothly carried out and backward-flow phenomena of the liquid coating composition supplied from each slit to the slit as well as slit clogging due to that was minimized. Thus, it was possible to confirm that the aforesaid coating method was a coating method which made it possible to continuously carry out excellent coating which resulted in no streaking problems.

TABLE 1

| | Solvent Flowed | | | | |
|---|---|---|---|---|---|
| | from Uppermost | | | | |
| | Layer | | | Surface | |
| | Boiling | | | Flow | |
| | Point | Rate | | Air | |
| Solvent | of | Flow | Coating | Rate | Streaking |
| Type | Solvent | ml/min. | Width m | m/sec. | Problem |
| 1 Type | — | 0 | 1.5 | 0.5 | *1 |
| 1 Type | 80 | 50 | 1.5 | 0.5 | *2 |
| 1 Type | 80 | 200 | 1.5 | 0.5 | 0 line/m |
| 1 Type | 80 | 200 | 1.5 | 0.5 | 0 line/m |
| 1 Type | 80 | 2000 | 1.5 | 0.5 | 0 line/m |
| 1 Type | 80 | 5000 | 1.5 | 0.5 | 0 line/m |
| 1 Type | 80 | 8000 | 1.5 | 0.5 | 3 lines/m |
| 1 Type | 80 | 10000 | 1.5 | 0.5 | 2 lines/m |
| 2 Types | 85 | 50 | 1.5 | 0.5 | *3 |
| 2 Types | 85 | 200 | 1.5 | 0.5 | 0 line/m |
| 2 Types | 85 | 200 | 1.5 | 0.5 | 0 line/m |
| 2 Types | 85 | 2000 | 1.5 | 0.5 | 0 line/m |
| 2 Types | 85 | 5000 | 1.5 | 0.5 | 0 line/m |
| 2 Types | 85 | 8000 | 1.5 | 0.5 | 3 lines/m |
| 2 Types | 85 | 10000 | 1.5 | 0.5 | 1 line/m |
| 2 Types | 90 | 50 | 1.5 | 0.5 | *3 |
| 2 Types | 90 | 200 | 1.5 | 0.5 | 0 line/m |
| 2 Types | 90 | 200 | 1.5 | 0.5 | 0 line/m |
| 2 Types | 90 | 2000 | 1.5 | 0.5 | 0 line/m |
| 2 Types | 90 | 5000 | 1.5 | 0.5 | 0 line/m |
| 2 Types | 90 | 8000 | 1.5 | 0.5 | 4 lines/m |
| 2 Types | 90 | 10000 | 1.5 | 0.5 | 1 line/ |
| 1 Type | 80 | 2000 | 1.5 | 1.0 | 0 line/m |
| 1 Type | 80 | 2000 | 1.5 | 3.0 | 0 line/m |
| 1 Type | 80 | 2000 | 1.5 | 5.0 | 5 line/m |
| 2 Types | 85 | 2000 | 1.5 | 1.0 | 0 line/m |
| 2 Types | 85 | 2000 | 1.5 | 3.0 | 0 line/m |
| 2 Types | 85 | 2000 | 1.5 | 5.0 | 6 lines/m |
| 2 Types | 90 | 2000 | 1.5 | 1.0 | 0 line/m |
| 2 Types | 90 | 2000 | 1.5 | 3.0 | 0 line/m |
| 2 Types | 90 | 2000 | 1.5 | 5.0 | 8 lines/m |

*1; 30 or more lines/m
*2; 15 or more lines/m
*3; 20 or more lines/m

### Example 2

As similarly shown in Table 1, it was practically proved that it was possible to carry out excellent coating while the aforesaid solvents was employed individually, or in combinations of two or more, as long as it was a mixed solvent.

### Example 3

As similarly shown in Table 1, it was discovered that it was possible to carry out excellent coating, employing conditions in which the aforesaid solvent flow rate (ml/minute) satisfied the conditions of coating width (m)×50≦solvent flow rate≦solvent flow rate≦coating width (m)×5,000.

### Example 4

As similarly shown in Table 1, it was discovered that when the surface air flow rate was reached, for example 5 m/second while exceeding 3 m/second, slight streaking problems occurred, while when it was 3 m/second or less, desired coating was carried out, resulting in no streaking problems.

### Example 5

In a coating method in which a plurality of layers is simultaneously coated onto a continuously moving support, employing a slide bead coating system or a curtain coating system, it was confirmed that it was possible to carry out excellent coating, resulting in no problems, under the following conditions, as shown in Table 2. When at least one layer liquid coating composition at a viscosity of at least 300 mPa.s comprised volatile solvents, the minimum wet thickness of the lowermost layer was adjusted to be more than that obtained by the following formula, while the viscosity of the lowermost layer was 0.5-100 mPa.s.

Y=0.0005X²+0.0858X+1.75

wherein Y represents the wet thickness (μm) of the lowermost layer, and X represents the viscosity (mPa.s) of that lowermost layer.

TABLE 2

| First Layer | | | | | | |
|---|---|---|---|---|---|---|
| (Lowermost Layer) | | Second Layer | | Third Layer | | |
| | Layer | | Layer | | Layer | |
| | Thick- | | Thick- | | Thick | |
| Viscosity | ness | Viscosity | ness | Viscosity | ness | |
| mPa · s | μm | mPa · s | μm | mPa · s | μm | Coating |
| 0.5 | 1 | 1000 | 80 | 800 | 25 | NG |
| 0.5 | 2 | 1000 | 80 | 800 | 25 | OK |
| 0.5 | 5 | 1000 | 80 | 800 | 25 | OK |
| 12 | 2.5 | 1000 | 80 | 800 | 25 | NG |
| 12 | 3.5 | 1000 | 80 | 800 | 25 | OK |
| 12 | 5.0 | 1000 | 80 | 800 | 25 | OK |
| 30 | 4.0 | 1000 | 80 | 800 | 25 | NG |
| 30 | 5.0 | 1000 | 80 | 800 | 25 | OK |
| 30 | 7.5 | 1000 | 80 | 800 | 25 | OK |
| 60 | 5.0 | 1000 | 80 | 800 | 25 | NG |
| 60 | 10.0 | 1000 | 80 | 800 | 25 | OK |
| 60 | 15.0 | 1000 | 80 | 800 | 25 | OK |
| 105 | 10.0 | 1000 | 80 | 800 | 25 | NG |
| 105 | 17.0 | 1000 | 80 | 800 | 25 | OK |
| 105 | 20.0 | 1000 | 80 | 800 | 25 | OK |

### Example 6

In a coating method in which a plurality of layers is simultaneously coated onto a continuously moving support, employing a slide bead coating system or a curtain coating system, when at least one layer liquid coating composition at a viscosity of at least 300 mPa.s comprised volatile solvents, it was confirmed that it was possible to carry out excellent coating, resulting in no clogging of the slit for the lowermost layer due to the high viscosity liquid coating composition, by employing a coating method in which the supply of the liquid coating compositions to the coater was successively carried out from the lowermost layer liquid coating composition and it was also confirmed that the aforesaid method resulted in stable coating.

### Example 7

Further, it may be stated that it is preferable that the supply flow rate of the lowermost layer liquid coating composition is to be more than that of the layer above liquid coating composition.

### Example 8

It was confirmed that stable coating was achieved by adjusting the aforesaid supply flow rate of the lowermost layer liquid coating composition to the specified flow rate thereof so as to be delayed.

### Example 9

In a coating method in which a plurality of layers are simultaneously coated onto support 1 which is continuously moved by rotation of back roller 2 of the slide coater, shown in FIG. 1, while employing a slide bead coating method, the following coating method was tried. When at least one layer liquid coating composition at a viscosity of at least 300 mPa.s comprised volatile solvents, coating was carried out while setting bead gap B (μm) between minimum value Bₘᵢₙ and maximum value Bₘₐₓ of B, represented by the following formulas for optional coating speed A (m/minute) in the range of 5-50 m/minute.

Bₘᵢₙ=58·logₑA

Bₘₐₓ=185·logₑA−100

As shown in Table 3, under the aforesaid conditions, stable coating was carried out, while beyond them, it was impossible to continue coating due to instability.

TABLE 3

| Coating Speed | Bead Gap | |
|---|---|---|
| m/min. | μm | Coating |
| 5 | 90 | NG |
| 5 | 120 | OK |
| 5 | 175 | OK |
| 5 | 200 | NG |
| 5 | 250 | NG |
| 25 | 150 | NG |
| 25 | 200 | OK |
| 25 | 300 | OK |
| 25 | 400 | OK |
| 25 | 500 | OK |
| 25 | 600 | NG |
| 50 | 200 | NG |
| 50 | 300 | OK |
| 50 | 500 | OK |
| 50 | 600 | OK |
| 50 | 700 | NG |

### Example 10

In a coating method in which a plurality of layers are simultaneously coated onto support 1 which is continuously moved by rotation of back roller 2 of a slide coater, similar to that shown in FIG. 1, while employing a slide bead coating method, the following coating was carried out. When at least one layer liquid coating composition at a viscosity of at least 300 mPa.s comprised volatile solvents, coating was carried out while setting bead gap B (μm) calculated by the following formula as an optimal value for optional coating speed A (m/minute) in the range of 5-50 m/minute.

B=60·logₑA+60

As the graph with regard to the degree of stability of coating in FIG. 4, shows, it was possible to realize coating in the more stabilized region in the coating method shown in Example 9.

### Example 11

In a coating method in which a plurality of layers are simultaneously coated onto support 1 which is continuously moved by rotation of back roller 2 of the slide coater, similar to that shown in FIG. 1, while employing a slide bead coating method, coating was carried out under the following conditions. When at least one layer liquid coating composition at a viscosity of at least 300 mPa.s comprised volatile solvents, as shown in (a) plan view, (b) front view, and (c) side view of FIG. 2, the side section angle, which was an angle between leading edge inclination surface 4K on the leading edge (being a lip) on width regulating plate which regulated the coating width in slide surface 3S of coater die 3 of the aforesaid slide bead coating apparatus, and aforesaid slide surface 3S satisfied the condition of (α−40)°≦front section angle≦(α−5)°, wherein α represents the angle between the moving surface of support 1 and slide surface 3S of the aforesaid coater die 3, and front section angle≦side section angle≦90° was also satisfied.

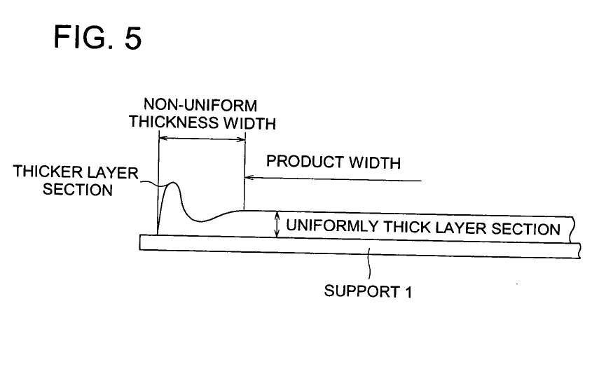

By such operations, it becomes possible to minimize phenomena such that the thickness of both edges across the width of the liquid coating composition applied onto the surface of the support increases, as shown in the schematic view of FIG. 5. When such an increase in the layer thickness occurs, drying load increases, and when drying is not completed, coating quality is markedly degraded. Further, even though drying would eventually be completed, when wound into a roll, the wound state is not sufficiently uniform and the resulting coating layer is thus subjected to non-uniform pressure. When light-sensitive materials are subjected to such non-uniform pressure, fogging occurs, resulting in major degradation in quality, diminishing the value of the product. However, by utilizing countermeasures shown in examples of the present invention, such problems are overcome.

### Example 12

In a coating method in which a plurality of layers are simultaneously coated onto a continuously moving support, employing a slide bead coating method, the following coating method was tried. When at least one layer liquid coating composition comprised volatile solvents at a viscosity of at least 300 mPa.s, as shown in FIG. 2, width regulating plate 4, which regulates the coating width on slide surface 3S was positioned so that leading edge 4L on the front side of aforesaid width regulating plate 4 was aligned with front bar lip 3L of coater die 3 of the slide bead coating apparatus. By these operations, the degree of increase in layer thickness was reduced compared to Example 11, whereby the coating quality as well as the winding quality was enhanced.

### Example 13

In a coating method in which a plurality of layers is simultaneously coated onto continuously moving support 1 employing coater die 3 of the slide bead coating apparatus, while employing a slide bead coating system, when at least one layer liquid coating composition at a viscosity of at least 300 mPa.s comprises volatile solvents, coating was carried out as follows. Chamber 5 was arranged which reduced pressure toward the upstream side in the support moving direction. Aforesaid chamber 5 was divided into a plurality of chambers (herein 2) such as chambers 5A and 5B, employing partition 5S. The pressure of both aforesaid chambers was reduced, while one was used to recover the waste liquid coating composition and the other was used for exhausted air.

Employing such a coating method, it was confirmed that when a high viscosity liquid coating composition was coated, coat mottling was consistently minimized.

Further, with regard to Examples 1-8, coating was carried out employing a curtain coating method, employing the curtain coating apparatus as shown in FIG. 3, in addition to coating employing the aforesaid slide bead coating method, whereby the same results were obtained.

In accordance with the present invention, the following results were obtained.

(1) During supply of a liquid coating composition, by arranging the boiling point of the solution, which was allowed to flow onto the slide surface, to be higher than that of the major solvent of the liquid coating composition, as well as by specifying the flow rate range, it was possible to minimize problems such as striping and mottling which resulted in degradation of coating quality. In addition, it was possible to enhance production efficiency.

(2) Even when the viscosity of the lowermost layer liquid coating composition was 100 Pa·s, it was possible to carry out coating by increasing the thickness of the aforesaid lowermost layer, whereby performance and quality were enhanced.

(3) By starting the supply to coater employing the lowermost layer, backward flow was minimized, whereby striping problems were minimized.

(4) When coating speed for coating a high viscosity liquid coating composition was once decided, it was possible to carry out excellent coating, employing the calculated bead gap based on the formula.

(5) By specifying the front angle of the width regulating plate as well as by allowing the position of the leading edge to agree with the front bar lip, an increase in the layer thickness at the coating edge was minimized, whereby it was possible to carry out production with no staining in the interior of processes and no problems in which it was impossible to carry out winding.

(6) In the case of coating the high viscosity liquid coating composition, by separating the vacuum mechanism for the liquid coating composition from the waste recovering mechanism, it was possible to minimize coat mottling as well as to improve quality.

Namely, by minimizing drying of the liquid coating composition on the coater, striping and mottling problems were minimized, and even when the viscosity of the lowermost layer was relatively high, it was possible to carry out coating by increasing the layer thickness, resulting in enhancement of both performance and physical properties. Further, it was possible to achieve stable coating for production.

What is claimed is:

1. A coating method, comprising:
coating plural layers simultaneously on a continuously moving support by flowing out simultaneously plural coating liquids from plural slits, wherein at least one of the plural coating liquids contains a volatile solvent;
stopping the coating step; and
flowing out a solution containing a solvent having a boiling point higher than that of a main solvent of a coating liquid from a slit for an uppermost layer of the plural layers while stopping the coating step.

2. The coating method of claim 1, wherein the solvent is one of a single solvent and a mixture of plural solvents.

3. The coating method of claim 1, wherein a flow of the solvent satisfies the following formula:
W×50≦Q≦W×5000
where Q is a flow quantity (ml/min) of the solvent and W is a coating width (m).

4. The coating method of claim 1, wherein a surface wind velocity at a position where the coating liquid flows is 3 m/sec or less.

5. The coating method of claim 1, wherein the coating method is one of a slide bead coating method and a curtain coating method and wherein when the coating liquid containing the volatile solvent has a viscosity of 200 mPa.s or more and a coating liquid of the lowermost layer has a viscosity of 0.5 to 100 mPa.s, a minimum wet layer thickness of the lowermost layer is thicker than a thickness obtained by the following formula:
Y=0.0005X²+0.0858X+1.75
where Y is a wet layer thickness (μm) of the lowermost layer and X is a viscosity (mPa.s) of the lowermost layer.

6. The coating method of claim 5, wherein when the coating liquid containing the volatile solvent has a viscosity of 200 mPa.s or more, plural coating liquids are sequentially fed from a lowermost layer coating liquid to an uppermost layer into the plural slits.

7. The coating method of claim 6, wherein a feeding quantity of the lowermost layer coating liquid is lager than that of an upper layer coating liquid.

8. The coating method of claim 6, wherein a feeding speed of the lowermost layer coating liquid is slower than that of an upper layer coating liquid.

9. A slide bead coating method, comprising:
coating plural layers simultaneously on a continuously moving support by flowing out simultaneously plural coating liquids from plural slits of a slide coater, wherein at least one of the plural coating liquids contains a volatile solvent and has a viscosity of 200 mPa.s or more; and
setting a bead gap (μm) within a range of a minimum gap Bmin to a maximum gap Bmax when a coating speed A is 5 to 50 (m/min), where the minimum gap Bmin and maximum gap Bmax are obtained by the following formulas:
Bmin=58·logₑA
Bmax=185·logₑA−100

10. The slide bead coating method of claim 9, wherein the optimum value Bopt of the bead gap is obtained by the following formula:
Bopt=60·logₑA+60

11. The slide bead coating method of claim 9, wherein the slide coater comprises a slide surface and width regulating plates provided at both sides of the slide surface and wherein the slide surface is located in close proximity to a coated surface of the continuously moving support with a slide angle θ_{α} to the coated surface, a tip end of each of the width regulating plates is slanted with a tip end angle θₜ to the slide surface, an inner side surface of each of the width regulating plates is slanted with an inner side angle θᵢ to the slide surface and the following formulas are satisfied:
(θ_{α}−40)°≦θₜθ≦(θ_{α}−5)°
θₜ≦θᵢ≦90°

12. The slide bead coating method of claim 11, wherein the edge of the tip end of the width regulating plates and the edge of the slide surface are positioned on the same straight line.

13. The slide bead coating method of claim 9, wherein the slide coater further comprises plural reduced-pressure chambers to apply a reduced-pressure to an entire bead toward an upstream side in a moving action of the support.
